(19) United States
(12) Patent Application Publication
(10) Pub. No.: US 2014/0291878 A1
(43) Pub. Date: Oct. 2, 2014

(54) METHODS FOR CONTROLLING ACROSS-WAFER DIRECTED SELF-ASSEMBLY

(71) Applicant: TOKYO ELECTRON LIMITED, Tokyo (JP)

(72) Inventor: Mark H. Somervell, Austin, TX (US)

(73) Assignee: Tokyo Electron Limited, Tokyo (JP)

(21) Appl. No.: 13/854,008

(22) Filed: Mar. 29, 2013

(51) Int. Cl. B29C 59/08

(52) U.S. Cl. CPC B29C 59/08
USPC 264/40.1

(57) ABSTRACT

A method for treating a layered substrate including a layer of a block copolymer is provided. The method includes identifying a non-uniformity in the layer of the block copolymer; controlling a process variable correlated to the non-uniformity in the layer of the block copolymer; and annealing the layer of the block copolymer under a process condition affected by the process variable to compensate for at least a portion of the non-uniformity in the layer of the block copolymer to form a pattern comprising a plurality of domains having improved uniformity therein. The method further provides a way for reducing a non-uniformity in a layered substrate comprising a layer of a block copolymer on a pre-patterned substrate.

### FIELD OF THE INVENTION

This disclosure is related to methods for improving non-uniformities in directed self-assembly integrated applications; and more specifically, to utilizing systematic process changes to compensate for non-ideal effects that lead to cross wafer non-uniformities.

### BACKGROUND OF THE INVENTION

Self-assemblable block copolymers may undergo an order-disorder transition resulting in phase separation of copolymer blocks of different chemical nature to form ordered, chemically distinct domains with dimensions of tens of nanometers or even less than 10 nm. The size and shape of the domains may be controlled by manipulating the molecular weight and composition of the different block types of the copolymer. Because self-assemblable block copolymers possess the ability to generate high resolution lithographic structures inexpensively, directed self assembly (DSA) of block copolymers is emerging as a useful tool to form lithographic structures.

There are a host of different integrations for DSA (e.g., chemi-epitaxy, grapho-epitaxy, hole shrink, etc.), but in all cases, the DSA technique depends on assembly of the block copolymer from a random unordered state into ordered, chemically distinct domains (e.g., a line/space or cylindrical morphology) that are useful for lithography. However, in order for the technique to be valuable, the domains should be created uniformly across a wafer (or other similar substrate). Non-uniformities across a wafer may arise from various sources. For example, spin casting induced film stresses, variations in block copolymer film thickness, and non-uniformities in an underlying grapho-epitaxy or chemi-epitaxy pre-pattern can produce non-uniformities in the resulting layer of self-assembled block copolymer.

Block copolymers are typically spin cast from solution form in a fashion similar to photoresists. Because angular momentum is a function of a radial distance from an axis of rotation, during the spin casting process the forming layer of the block copolymer experiences a higher centripetal force at the edge of wafer as compared to the central region of the wafer. Accordingly, the stresses in the cast block copolymer layer may be very different in the center versus the edges of the wafer. This difference in stress often results in a difference in the ability of the block copolymer to rearrange, thereby producing non-uniformities in the resultant self-assembled block copolymer layer.

In the assembly of vertical cylinders for making contact holes using grapho-epitaxy (also known as hole shrink DSA applications), the thickness of the block copolymer fill within a graphical hole is a factor than can affect the outcome of whether a given hole shrink feature is attained. For example, if the graphical holes are filled with block copolymer to a level equal to about the depth of the graphical hole, the resulting DSA process (after wet development processing) leads to the smallest number of missing holes. However, with spin-coating thin block copolymer layers of hole arrays, there is often a systematic center to edge variation that results from the difference in the centripal forces felt by the block copolymer layer. Thus, it is possible to have holes in the center of the wafer be “just-filled” and those at the edge of the wafer be half-filled. Similarly, in grapho-epitaxy applications for line/space patterning, trench templates (also known as weirs) are used to direct the assembly of either lamellar line/space patterns or horizontal cylindrical patterns. Again, the degree to which the block copolymer fills the trench is a factor than can affect the quality of the self-assembled block copolymer, and the fill characteristic from center to edge will drive the uniformity of the self-assembled block copolymer across the wafer.

Moreover, in grapho-epitaxy applications (both line/space and contact hole), the assembly is directed by a physical structure on the wafer. These structures are generated through typical lithographic methods, which can have their own non-uniformities. If, for example, the profile of the grapho-epitaxy feature varies across the wafer, there may well be a center to edge difference in the assembly of the block copolymer. Similarly, in chemi-epitaxy applications, etch processes are often required to create areas of differing chemical activity in the substrate. These etch processes can also have center to edge uniformity issues, which may result in a different chemical template in the center of the wafer versus the edge of the wafer, and this difference in chemical template directly impacts the assembly of the block copolymer.

In view of the center to edge non-uniformities described above that can exist in wafers comprising layers of block copolymers, a need exists for methods of processing wafers that counteracts this systematic issue in DSA integrations.

### SUMMARY OF THE INVENTION

Embodiments of the invention provide methods for treating a layered substrate comprising a layer of a block copolymer. The methods are useful for reducing a non-uniformity in a layered substrate comprising a self-assembled block copolymer layer. In accordance with an embodiment, a method for treating a layered substrate comprising a layer of a block copolymer is provided. The method comprises identifying a non-uniformity in the layer of the block copolymer; controlling a process variable correlated to the non-uniformity in the layer of the block copolymer; and annealing the layer of the block copolymer under a process condition affected by the process variable to compensate for at least a portion of the non-uniformity in the layer of the block copolymer to form a pattern comprising a plurality of domains having improved uniformity therein.

In accordance with another embodiment, a method for reducing a non-uniformity in a layered substrate comprising a layer of a block copolymer on a pre-patterned substrate is provided. The method comprises providing identifying the non-uniformity in the layered substrate; controlling a process variable correlated to the non-uniformity in the layered substrate; and annealing the layer of the block copolymer under a process condition affected by the process variable to compensate for at least a portion of the non-uniformity in the layered substrate to form a pattern comprising a plurality of domains having improved uniformity therein.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to describe the invention.

FIG. 1 is graphical representation of a radial non-uniformity in a layer of a block copolymer of a layered substrate;

FIG. 2 is a flow chart illustrating a method for treating a layered substrate comprising a layer of a block copolymer, in accordance with an embodiment of the invention; and

FIG. 3 is flow chart illustrating alternative process variables, which are controlled in a manner correlated to a non-uniformity in the layer of the block copolymer, in accordance with the method illustrated in FIG. 2.

### DETAILED DESCRIPTION OF THE DRAWINGS

Methods for treating a layered substrate comprising a layer of a block copolymer to reduce a non-uniformity in the layered substrate are disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention.

Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale. In referencing the figures, like numerals refer to like parts throughout.

Reference throughout this specification to “one embodiment” or “an embodiment” or variation thereof means that a particular feature, structure, material, or characteristic described in connection with the embodiment is included in at least one embodiment of the invention, but do not denote that they are present in every embodiment. Thus, the appearances of the phrases such as “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Additionally, it is to be understood that “a” or “an” may mean “one or more” unless explicitly stated otherwise.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

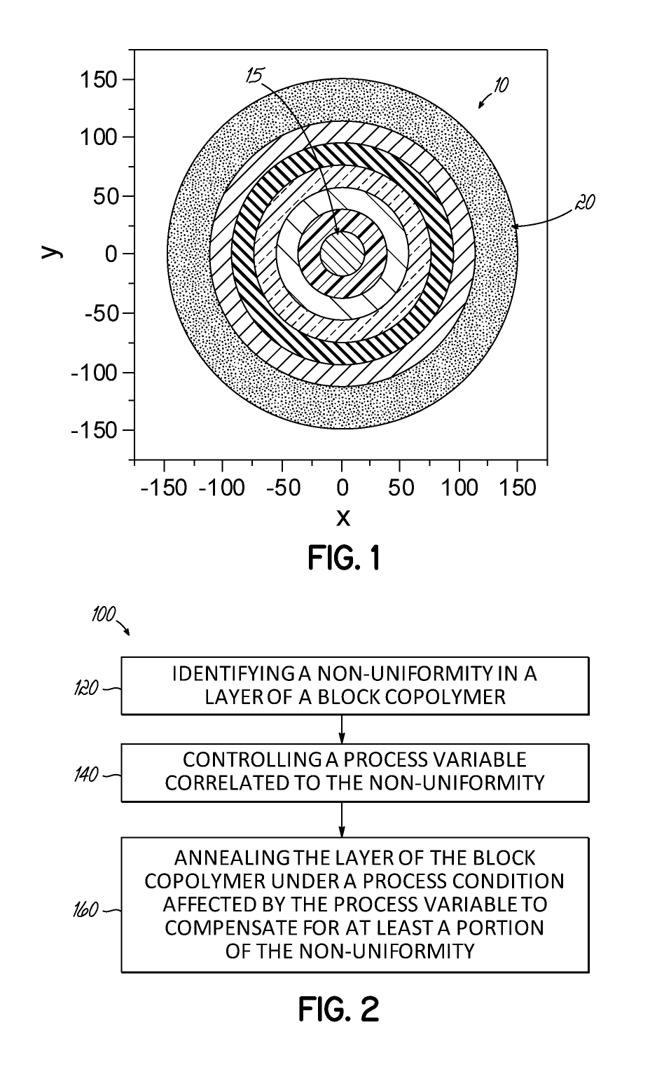

In reference to FIG. 1, a graphical representation of a radial non-uniformity in a layer of a block copolymer of a layered substrate 10 is provided. The layered substrate 10 in FIG. 1 is presented as an exemplary circular form of a wafer having a central region 15 surrounded by an edge region 20. In the process of spin coating the wafer, the wafer is rotated about an axis of rotation represented by the x, y coordinates 0,0 in FIG. 1. As the shading indicates, one commonly encountered systematic non-uniformity in a spin casted layer of a block copolymer is a center to edge variation in film stress.

Referring to FIG. 2 and in accordance with embodiments of the present invention, a method 100 is provided for treating a layered substrate comprising a layer of a block copolymer. The method 100 includes identifying a non-uniformity in the layer of the block copolymer in step 120, wherein the non-uniformity comprises a center to edge variation in the layer of the block copolymer; controlling a process variable correlated to the non-uniformity in the layer of the block copolymer in step 140; and annealing the layer of the block copolymer under a process condition affected by the process variable in step 160, to compensate for at least a portion of the non-uniformity in the layer of the block copolymer to form a domain pattern comprising a plurality of domains having a reduced non-uniformity therein. Accordingly, the method is useful for reducing a non-uniformity in a layered substrate comprising a self-assembled block copolymer layer.

As used herein, the term “polymer block” means and includes a grouping of multiple monomer units of a single type (i.e., a homopolymer block) or multiple types (i.e., a copolymer block) of constitutional units into a continuous polymer chain of some length that forms part of a larger polymer of an even greater length and exhibits a χN value, with other polymer blocks of unlike monomer types, that is sufficient for phase separation to occur. χ is the Flory-Huggins interaction parameter and N is the total degree of polymerization for the block copolymer. According to embodiments of the present invention, the χN value of one polymer block with at least one other polymer block in the larger polymer may be equal to or greater than about 10.5.

As used herein, the term “block copolymer” means and includes a polymer composed of chains where each chain contains two or more polymer blocks as defined above and at least two of the blocks are of sufficient segregation strength (e.g. χN>10.5) for those blocks to phase separate. A wide variety of block polymers are contemplated herein including diblock copolymers (i.e., polymers including two polymer blocks (AB)), triblock copolymers (i.e., polymers including three polymer blocks (ABA or ABC)), multiblock copolymers (i.e., polymers including more than three polymer blocks (ABCD, etc.)), including star-shaped or miktoarm block copolymers, and combinations thereof.

As used herein, the term “substrate” means and includes a base material or construction upon which materials are formed. It will be appreciated that the substrate may include a single material, a plurality of layers of different materials, a layer or layers having regions of different materials or different structures in them, etc. These materials may include semiconductors, insulators, conductors, or combinations thereof. For example, the substrate may be a semiconductor substrate, a base semiconductor layer on a supporting structure, a metal electrode or a semiconductor substrate having one or more layers, structures or regions formed thereon. The substrate may be a conventional silicon substrate or other bulk substrate comprising a layer of semiconductive material. As used herein, the term “bulk substrate” means and includes not only silicon wafers, but also silicon-on-insulator (“SOI”) substrates, such as silicon-on-sapphire (“SOS”) substrates and silicon-on-glass (“SOG”) substrates, epitaxial layers of silicon on a base semiconductor foundation, and other semiconductor or optoelectronic materials, such as silicon-germanium, germanium, gallium arsenide, gallium nitride, and indium phosphide. The substrate may be doped or undoped.

The terms “microphase segregation” and “microphase separation,” as used herein mean and include the properties by which homogeneous blocks of a block copolymer aggregate mutually, and heterogeneous blocks separate into distinct domains. In the bulk, block copolymers can self assemble into ordered morphologies, having spherical, cylindrical, lamellar, or bicontinuous gyroid microdomains, where the molecular weight of the block copolymer dictates the sizes of the microdomains formed. The domain size or pitch period (L₀) of the self-assembled block copolymer morphology may be used as a basis for designing critical dimensions of the patterned structure. Similarly, the structure period (L_{S}), which is the dimension of the feature remaining after selectively etching away one of the polymer blocks of the block copolymer, may be used as a basis for designing critical dimensions of the patterned structure.

The lengths of each of the polymer blocks making up the block copolymer may be an intrinsic limit to the sizes of domains formed by the polymer blocks of those block copolymers. For example, each of the polymer blocks may be chosen with a length that facilitates self-assembly into a desired pattern of domains, and shorter and/or longer copolymers may not self-assemble as desired.

The term “annealing” or “anneal” as used herein means and includes treatment of the block copolymer so as to enable sufficient microphase segregation between the two or more different polymeric block components of the block copolymer to form an ordered pattern defined by repeating structural units formed from the polymer blocks. Annealing of the block copolymer in the present invention may be achieved by various methods known in the art, including, but not limited to: thermal annealing (either in a vacuum or in an inert atmosphere, such as nitrogen or argon), solvent vapor-assisted annealing (either at or above room temperature), or supercritical fluid-assisted annealing. Other conventional annealing methods not described herein may also be utilized. Moreover, one or more combinations of annealing techniques may also be utilized. As a specific example of a combination of anneal processes, a thermal annealing of the block copolymer may be conducted first by exposing the block copolymer to an elevated temperature that is above the order-disorder temperature (ODT), but below the degradation temperature (T_{d}) of the block copolymer, which is then followed by a solvent vapor-assisted annealing process.

The term “preferential wetting,” as used herein, means and includes wetting of a contacting surface by a block copolymer wherein one polymer block of the block copolymer will wet a contacting surface at an interface with lower free energy than the other block(s). For example, preferential wetting may be achieved or enhanced by treating the contacting surface with a material that attracts a first polymer block and/or repels a second polymer block of the block copolymer.

The ability of block copolymers to self-organize may be used to form mask patterns. Block copolymers are formed of two or more chemically distinct blocks. For example, each block may be formed of a different monomer. The blocks are immiscible or thermodynamically incompatible, e.g., one block may be polar and the other may be non-polar. Due to thermodynamic effects, the copolymers will self-organize in solution to minimize the energy of the system as a whole; typically, this causes the copolymers to move relative to one another, e.g., so that like blocks aggregate together, thereby forming alternating regions containing each block type or species. For example, if the copolymers are formed of polar (e.g. organometallic-containing polymers) and non-polar blocks (e.g., hydrocarbon polymers), the blocks will segregate so that non-polar blocks aggregate with other non-polar blocks and polar blocks aggregate with other polar blocks. It will be appreciated that the block copolymers may be described as a self-assembling material since the blocks can move to form a pattern without active application of an external force to direct the movement of particular individual molecules, although heat may be applied to increase the rate of movement of the population of molecules as a whole.

In addition to interactions between the polymer block species, the self-assembly of block copolymers can be influenced by topographical features, such as steps, guides, or posts extending perpendicularly from the horizontal surface on which the block copolymers are deposited. For example, a diblock copolymer, a copolymer formed of two different polymer block species, may form alternating domains, or regions, which are each formed of a substantially different polymer block species. When self-assembly of polymer block species occurs in the area between the perpendicular walls of a step or guides, the steps or guides may interact with the polymer blocks such that, e.g., each of the alternating regions formed by the blocks is made to form a regularly spaced apart pattern with features oriented generally parallel to the walls and the horizontal surface.

Such self-assembly can be useful in forming masks for patterning features during semiconductor fabrication processes. For example, one of the alternating domains may be removed, thereby leaving the material forming the other region to function as a mask. The mask may be used to pattern features such as electrical devices in an underlying semiconductor substrate. Methods for forming a copolymer mask are disclosed in U.S. Pat. No. 7,579,278; and U.S. Pat. No. 7,723,009, the entire disclosure of each of which is incorporated by reference herein.

According to an embodiment of the present invention, the directed self-assembly block copolymer is a block copolymer comprising a first polymer block and a second polymer block, where the first polymer block inherently has an etch selectivity greater than 2 over the second block polymer under a first set of etch conditions. According to one embodiment, the first polymer block comprises a first organic polymer, and the second polymer block comprises a second organic polymer. In another embodiment, the first polymer block is an organic polymer and the second polymer block is an organometallic-containing polymer. As used herein, the organometallic-containing polymer includes polymers comprising inorganic materials. For example, inorganic materials include, but are not limited to, metalloids such as silicon, and/or transition metals such as iron.

It will be appreciated that the total size of each block copolymer and the ratio of the constituent blocks and monomers may be chosen to facilitate self-organization and to form organized block domains having desired dimensions and periodicity. For example, it will be appreciated that a block copolymer has an intrinsic polymer length scale, the average end-to-end length of the copolymer in film, including any coiling or kinking, which governs the size of the block domains. A copolymer solution having longer copolymers may be used to form larger domains and a copolymer solution having shorter copolymers may be used to form smaller domains.

Moreover, the types of self-assembled microdomains formed by the block copolymer are readily determined by the volume fraction of the first block component to the second block components.

According to one embodiment, when the volume ratio of the first block component to the second block component is greater than about 80:20, or less than about 20:80, the block copolymer will form an ordered array of spheres composed of the second polymeric block component in a matrix composed of the first polymeric block component. Conversely, when the volume ratio of the first block component to the second block component is less than about 20:80, the block copolymer will form an ordered array of spheres composed of the first polymeric block component in a matrix composed of the second polymeric block component.

When the volume ratio of the first block component to the second block component is less than about 80:20 but greater than about 65:35, the block copolymer will form an ordered array of cylinders composed of the second polymeric block component in a matrix composed of the first polymeric block component. Conversely, when the volume ratio of the first block component to the second block component is less than about 35:65 but greater than about 20:80, the block copolymer will form an ordered array of cylinders composed of the first polymeric block component in a matrix composed of the second polymeric block component.

When the volume ratio of the first block component to the second block component is less than about 65:35 but is greater than about 35:65, the block copolymer will form alternating lamellae composed of the first and second polymeric block components.

Therefore, the volume ratio of the first block component to the second block component can be readily adjusted in the block copolymer in order to form desired self-assembled periodic patterns. According to embodiments of the present invention, the volume ratio of the first block component to the second block component is less than about 80:20 but greater than about 65:35 to yield an ordered array of cylinders composed of the second polymeric block component in a matrix composed of the first polymeric block component.

Exemplary organic polymers include, but are not limited to, poly(9,9-bis(6′-N,N,N-trimethylammonium)-hexyl)-fluorene phenylene) (PFP), poly(4-vinylpyridine) (4PVP), hydroxypropyl methylcellulose (HPMC), polyethylene glycol (PEG), poly(ethylene oxide)-co-poly(propylene oxide) di- or multiblock copolymers, poly(vinyl alcohol) (PVA), poly(ethylene-co-vinyl alcohol) (PEVA), poly(acrylic acid) (PAA), polylactic acid (PLA), poly(ethyloxazoline), a poly(alkylacrylate), polyacrylamide, a poly(N-alkylacrylamide), a poly(N,N-dialkylacrylamide), poly(propylene glycol) (PPG), poly(propylene oxide) (PPO), partially or fully hydrolyzed poly(vinyl alcohol), dextran, polystyrene (PS), polyethylene (PE), polypropylene (PP), polyisoprene (PI), polychloroprene (CR), a polyvinyl ether (PVE), poly(vinyl acetate) (PV_{Ac}), poly(vinyl chloride) (PVC), a polyurethane (PU), a polyacrylate, a polymethacrylate, an oligosaccharide, or a polysaccharide.

Exemplary organometallic-containing polymers include, but are not limited to, silicon-containing polymers such as polydimethylsiloxane (PDMS), polyhedral oligomeric silsesquioxane (POSS), or poly(trimethylsilylstyrene (PTMSS), or silicon- and iron-containing polymers such as poly(ferrocenyldimethylsilane) (PFS).

Exemplary block copolymers include, but are not limited to, diblock copolymers such as polystyrene-b-poly(methyl methacrylate) (PS-PMMA), polystyrene-b-polydimethylsiloxane (PS-PDMS), poly(2-vinylpyridine)-b-polydimethylsiloxane (P2VP-PDMS), polystyrene-b-poly(ferrocenyldimethylsilane) (PS-PFS), or polystyrene-b-poly-DL-lactic acid (PS-PLA), or triblock copolymers such as polystyrene-b-poly(ferrocenyldimethylsilane)-b-poly(2-vinylpyridine) (PS-PFS-P2VP), polyisoprene-b-polystyrene-b-poly(ferrocenyldimethylsilane) (PI-PS-PFS), or polystyrene-b-poly(trimethylsilylstyrene)-b-polystyrene (PS-PTMSS-PS). In one embodiment, a PS-PTMSS-PS block copolymer comprises a poly(trimethylsilylstyrene) polymer block that is formed of two chains of PTMSS connected by a linker comprising four styrene units. Modifications of the block copolymers is also envisaged, such as that disclosed in U.S. Patent Application Publication No. 2012/0046415, the entire disclosure of which is incorporated by reference herein.

In one particular embodiment, the block copolymer used for forming the self-assembled periodic patterns is a PS-PDMS block copolymer. The polystyrene (PS) and the polydimethylsiloxane (PDMS) blocks in such a PS-PDMS block copolymer can each have a number average molecular weight ranging from about 10 kg/mol to about 100 kg/mol, with a number average molecular weight from about 20 kg/mol to about 50 kg/mole being more typical. Additionally, the volume fraction of the PDMS (f_{PDMS}) can range from about 20% to about 35%. In one embodiment, a PS-PDMS block copolymer having a 16 kg/mol molecular weight, with 33 vol % PDMS, provides cylindrical features having an 8 nm structure period (L_{S}). In another embodiment, a PS-PDMS block copolymer having a 32 kg/mol molecular weight with 33% PDMS provides cylindrical features having a 16 nm structure period (L_{S}).

Embodiments of the invention may also allow for the formation of features smaller than those that may be formed by block polymers alone or photolithography alone. In embodiments of the invention, a self-assembly material formed of different chemical species is allowed to organize to form domains composed of like chemical species. Portions of those domains are selectively removed to form temporary placeholders and/or mask features. A pitch multiplication process may then be performed using the temporary placeholders and/or mask features formed from the self-assembly material. Features with a pitch smaller than a pitch of the temporary placeholders may be derived from the temporary placeholders.

In some embodiments, inorganic guides or spacers are formed on sidewalls of temporary placeholders and the temporary placeholders may then be selectively removed. The inorganic guides, or other mask features derived from the guides, are used as part of a mask to pattern underlying materials, e.g., during the fabrication of integrated circuits.

Embodiments of the invention may form the mask features without using newer, relatively complex and expensive lithography techniques and the burden on the robustness of photoresist may be reduced. For example, rather than using relatively soft and structurally delicate photoresist in a mask, inorganic guides or mask features derived from the guides may be used as a mask. The use of inorganic guides allows the selection of a variety of materials for the guides, and the materials may be selected for robustness and compatibility with underlying materials used in a process flow.

Moreover, because the block copolymer material is also used as a mask for patterning underlying layers, the copolymer material is selected not only on its self-assembly behavior, but also based on its etch selectivity between the polymer blocks. Accordingly, the self-assembly behavior of the block copolymers allows the reliable formation of very small features, thereby facilitating the formation of a mask with a very small feature size. For example, features having a critical dimension of about 1 nm to about 100 nm, about 3 nm to about 50 nm or about 5 nm to about 30 nm may be formed.

In accordance with an embodiment, the non-uniformity present in the layered substrate comprises a center to edge variation. As discussed above, one exemplary systematic non-uniformity that can be present in the layered substrate that can be introduced during the fabrication process is by way of spin casting the layer of the block copolymer. The relative variations in angular momentum inherently present in a rotating wafer can cause center to edge variations, such as non-uniformities in film stress and fill levels in holes and weirs. During a typical annealing process, the process conditions, e.g., temperature, pressure, and/or concentration of gases or solvent vapors, are generally uniform throughout a processing chamber thereby providing a unitary set of annealing conditions across the wafer for inducing the microphase segregation of the polymer blocks of the block copolymer to form an ordered pattern defined by repeating structural units formed from the polymer blocks, i.e., domains.

The micro-phase separation that is observed in these systems is that of one polymer block diffusing within another polymer block Diffusion rates are known to depend on the size of the molecules that are diffusing, so the polymer block diffusion that occurs in block copolymers is much different than the diffusion of small molecules through thin polymer films. Specifically, the chain entanglement associated with polymer block diffusion creates an addition activation barrier that must be overcome before one polymer block can move within another. Accordingly, non-uniformities in the layer of the block copolymer can cause non-uniform diffusion rates that subsequently result in non-uniformities in the self-assembled block copolymer layer after subjecting the layered substrate to a unitary set of annealing conditions.

To compensate for these non-uniformities, it is advantageous to identify the region(s) of non-uniformities present in the layer of the block copolymer prior to anneal processing. Such non-uniformities (or defects) may manifest themselves as dislocations or disclinations in line/space patterns, or as a missing hole structure in an array of contacts. According to one embodiment, optical spectroscopy techniques, such as optical reflectometry, can be used to identify variations in film thickness prior to annealing a specific layered substrate and then correlate one or more anneal process variable to the non-uniformity. Alternatively, in the case of a systematic non-uniformity, the non-uniformities can be emprically ascertained by subjecting a first layered substrate to a unitary set of annealing conditions and further processed and analyzed to identify the consequent non-uniformities in the self-assembled block copolymer layer. The information can be used to correlate one or more anneal process variables to modify the anneal process conditions to counter the systematic non-uniformity, and can thus be used as a control parameter to counter the systematic non-uniformity signature in a process control loop. For example, the systematic non-uniformity signature may be identified in the process chamber using an optical metrology tool positioned therein, and then either fed back to the anneal system to adjust one or more anneal process variables to modify the anneal process conditions concurrently with the anneal, or fed forward to a secondary piece of equipment that might further process the wafer to compensate for the systematic non-uniformity signature.

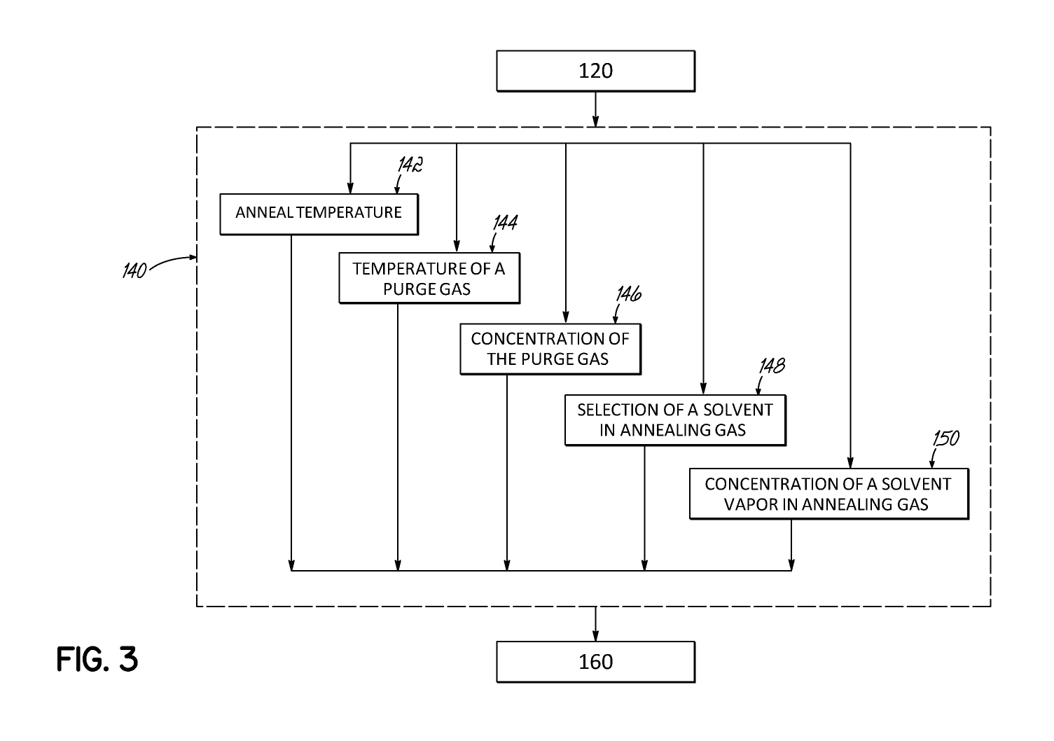

In accordance with an embodiment of the present invention and in reference to FIG. 3, the process variables in method 100 that can be controlled and are correlated in step 140 include, but are not limited to, an annealing temperature in step 142; a temperature of a purge gas in step 144; a concentration of the purge gas in step 146; a selection of a solvent in a solvent vapor-assisted annealing gas in step 148; a concentration of a solvent vapor in the solvent-assisted annealing gas in step 150; or combinations thereof.

In accordance with an embodiment, a thermal anneal system can be utilized to provide heating to the layered substrate, wherein the heating in a specific zone is correlated to a non-uniformity in the layer of the block copolymer. For example, a systematic center to edge temperature variation can be applied to the wafer that will counter the difference in assembly from center to edge. Such a variation could be created with a standard hot plate configured with zoned heating capability, such as concentric ringed heating elements or a grid-array of heating elements. Additionally, a variety of other heat source hardware, such as optical bakes, laser bakes, microwave bakes, which are also configured deliver the thermal energy in a zoned exposure, may also be used as suitable heat sources.

Without being bound by any particular theory, one principle believed to be in operation in the embodiments of the present invention is that by varying the temperature in correlation to the non-uniformity, the relative diffusion rates of the non-uniform regions are, in effect, brought into uniformity with its surrounding regions. The self-assembly of block copolymers occurs through a diffusive process. In a thermally annealed case, the diffusion of the block copolymers can be controlled through higher temperatures or longer treatment times, and either can be used to provide a stronger self-assembling impetus. In the context of diffusion, time and temperature are related through the diffusion length. Commonly, this is defined as:

L_{D}=\sqrt{2Dt} Equation (1)

where D is the Diffusivity (units of length²/time) and t is the anneal treatment time. Although not explicitly given in this equation, D is temperature dependent and follows an Arrhenius behavior:

$$D = {D}_{o} \text{?} \\ \text{?} \text{indicates text missing or illegible when filed} \qquad Equation ( 2 )$$

where Dₒ is a pre-exponential term, E_{D} is the activation energy for diffusion, R is the gas constant, and T is temperature. Combining (1) and (2) above provides the general expression:

$${L}_{D} = \sqrt{2 {tD}_{o} {e}^{\frac{- {E}_{D}}{RT}}} \qquad Equation ( 3 )$$

In an embodiment of the present invention, the method 100 is addressing an exemplary situation where the center and the edge of the wafer are such that the desired level of self-assembly is realized in one region (e.g., the central region) of the wafer during an anneal treatment time (t), but the same or substantially similar level of self-assembly is not realized in the other region (e.g., the edge region). While, in some instances, it may be possible to drive the entirety of the non-uniform regions by increasing the anneal treatment time and/or the annealing temperature, the increased processing time and/or temperature results in lower throughput and can also induce oxidative degradation of the block copolymer. Moreover, in a standard heat plate apparatus, it is difficult to apply a different time to different regions of the wafer.

Thus in accordance with an aspect of the present invention, the anneal treatment time (t) for the non-uniform regions, which are characterized as having lower diffusion rates, to achieve the desired level of self assembly can be emprically determined. Mathematically, the difference in diffusivity could be attributed to a difference of the pre-exponential factor, Dₒ, or the activation energy, E_{D}. However, the process is activated by temperature, so the difference in diffusivity may be presumed to be a result from a difference in the activation energy, and the pre-exponential constant may be assume to be substantially equivalent in the two regions. Accordingly, Equations 4 and 5, shown below, represent the diffusion lengths of two non-uniform regions 1 and 2:

$$\begin{matrix}{L}_{D , 1} = \sqrt{2 {t}_{1} {D}_{o} {e}^{\frac{- {E}_{D , 1}}{RT}}} & Equation ( 4 ) \\ {L}_{D , 2} = \sqrt{2 {t}_{2} {D}_{o} {e}^{\frac{- {E}_{D , 2}}{RT}}} & Equation ( 5 )\end{matrix}$$

If, for example, the empirically determined anneal treatment time (t) for the non-uniform region is twice that for the surrounding uniform regions, the diffusion lengths, L_{D,1}, L_{D,2}, would become equal (in accordance with the foregoing assumptions) then t₂ is twice t₁. Accordingly, Equations (4) and (5) can be set equal to each other and substitute for t₂ as follows:

$$\sqrt{2 {t}_{1} {D}_{o} {e}^{\frac{- {E}_{D , 1}}{RT}}} = \sqrt{2 ( 2 {t}_{1} ) {D}_{o} {e}^{\frac{- {E}_{D , 2}}{RT}}} \qquad Equation ( 6 )$$

Simple mathematical manipulation by cancelling terms, removing the radical, and taking the natural log of both sides provides simplified equations (7) and (8)

$$\begin{matrix} \frac{\text{?}}{RT} = ln ( 2 ) + \frac{\text{?}}{RT} & Equation ( 7 ) \\ {E}_{D , 2} - {E}_{D , 1} = RT ln ( 2 ) \\ \text{?} \text{indicates text missing or illegible when filed} & Equation ( 8 )\end{matrix}$$

So in this exemplary scenario, where the anneal treatment time (t) for the non-uniform region is twice that for the surrounding uniform regions, Equation 8 provide a mathematical relationship of the two activation energies. If the anneal treatment time (t) for the non-uniform region is five times that for the surrounding uniform regions, the right hand side of Equation 9 would be RTIn(5) instead.

In view of the foregoing, to attain equivalent performance through varied or zoned anneal temperatures, the above Equations 4 and 5 can be rewritten as follows

$$\begin{matrix} {L}_{D , 2} = \sqrt{2 t {D}_{o} {e}^{\frac{- {E}_{D , 2}}{{RT}_{2}}}} & Equation ( 9 ) \\ {L}_{D , 1} = \sqrt{2 t {D}_{o} \text{?}} \\ \text{?} \text{indicates text missing or illegible when filed} & Equation ( 10 )\end{matrix}$$

In this embodiment, the anneal treatment time (t) is constant and T₁ and T₂ represent the two different anneal temperatures, which correspond to non-uniform region (1) and uniform region (2), used to attain the desired level of self-assembly. As before, the polymer diffusion lengths are equated to get

$$\sqrt{2 t {D}_{o} {e}^{\frac{- {E}_{D , 1}}{{RT}_{1}}}} = \sqrt{2 t {D}_{o} {e}^{\frac{- {E}_{D , 2}}{{RT}_{2}}}} , \qquad Equation ( 11 )$$

And simple mathematical manipulation by cancelling terms, removing the radical, and taking the natural log of both sides provides Equations 12 or 13:

$$\begin{matrix}\frac{{E}_{D , 1}}{{RT}_{1}} = \frac{{E}_{D , 2}}{{RT}_{2}} & Equation ( 12 ) \\ {T}_{2} = \frac{{E}_{D , 2} {T}_{1}}{{E}_{D , 1}} & Equation ( 13 )\end{matrix}$$

If the empirically derived anneal treatment time (t) for the non-uniform region (2) is two times that for the surrounding uniform regions (1), the relationships between the activation energies in equation 8 is valid, and we can substitute into equation 13 to provide simplified equations (14) and (15):

$$\begin{matrix}{T}_{2} = \frac{( {E}_{D , 1} + RT LN ( 2 ) ) {T}_{2}}{{E}_{D , 1}} & Equation ( 14 ) \\ {T}_{2} = ( 1 + \frac{RT LN ( 2 )}{{E}_{D , 1}} ) {T}_{1} & Equation ( 15 )\end{matrix}$$

Thus, in accordance with an embodiment of the present invention, the foregoing mathematical relationships and emprically derived anneal treatment times and/or temperatures can allow the design of multiple heating zones in a zoned thermal anneal system to compensate for at least a portion of the non-uniformity in a layered substrate comprising a layer of a block copolymer to form a pattern comprising a plurality of domains having improved uniformity therein.

For example, for a polystyrene (PS):polyisoprene (PI) block copolymer characterized as having a number average molecular weight (Mn) for the PS and PI blocks of 1.0×10⁴ and 1.3×10⁴ g/mol, respectively; and a volume fraction of PS of 0.40 (calculate using densities of 1.05 and 0.91 g/mL for PS and PI, respectively), the anneal temperature in a first region (e.g., a region of substantially uniform properties) can be about 150° C., while the anneal temperature in a second region (e.g., a region that is non-uniform with respect to the first region) can be about 187° C.), (see Equations in Lodge et al., “Self-Diffusion of a Polystyrene-Polyisoprene Block Copolymer,” Journal of Polymer Science, Part B: Polymer Physics, Vol. 34, 2899-2909 (1996).

The foregoing zoned thermal anneal system can be used to anneal block copolymers that form lamellar, horizontal cylinders, vertical cylinders, or spherical domains. Suitable block copolymers may have χ values in a range from about 0.03 to about 0.30. These block copolymers can be directed by line/space chemical substrates, chemical substrates composed of circular spots, graphical line/space templates, or cylindrical graphical templates, for example.

In accordance with another embodiment, a thermal anneal system using a nitrogen (or other inert gas) purge gas to prevent oxidation can be used to provide zoned heat transfer correlated to the non-uniformity. For example, the delivery of the gas within the chamber can be modified to enhance the assembly either being configured with a secondary temperature control method, or by influencing the heat transfer capability of the purge gas by varying the concentration of the purge gas itself. Accordingly, the flow of the purge gas through the process chamber convectively removes heat from the system in combination with the heating (e.g., with a hot plate) of the substrate. The foregoing purge gas-facilitated zone heat transfer anneal system can be used to anneal block copolymers forming lamellar, horizontal cylinders, vertical cylinders, or spherical domains. Suitable block copolymers may have χ values in a range from about 0.03 to about 0.30. These block copolymers can be directed by line/space chemical substrates, chemical substrates composed of circular spots, graphical line/space templates, or cylindrical graphical templates

In accordance with another embodiment, in a solvent vapor-assisted anneal system, the solvent vapor-assisted annealing gas environment may be controlled through the flow of the annealing gas into the process chamber. Depending on the point of injection and geometry of the chamber, the concentration of a solvent vapor in the solvent vapor-assisted annealing gas can be correlated to the non-uniformity in the layer of the block copolymer across regions of the wafer. A higher partial pressure of the solvent vapor in the solvent vapor-assisted annealing gas will provide a higher driving force for solvent absorption in the areas exposed thereto and will provide the additional capacity for higher diffusion rates.

In such solvent vapor-assisted annealing gas systems, the solvents that are used to anneal the block copolymers are typically tailored with the block copolymers. The chemical nature of the solvent(s) with respect to the subject block copolymer is either a selective or a non-selective (or neutral) solvent. A selective solvent is one that prefers one of the block of the block copolymer over the other(s). In the case of a triblock or higher order block copolymer, a selective solvent may prefer two or more blocks over another block. A neutral solvent is a solvent in which all blocks of the block copolymer have good solubility.

The choice of solvent can affect the maximum solvent volume fraction, morphology, and domain size of the assembled film. Phases of block copolymer/solvent systems can depend on the volume fraction of the solvent as well as the temperature and relative volume fractions of the blocks. For example, the morphology of a symmetric diblock copolymer annealed in a selective solvent at low temperature may change from lamellae, gyroid, cylinder, sphere, and micelles upon increase of solvent fraction.

Solvents may be generally organic in nature. Common organic solvents useful for solvent vapor-assisted annealing include, but are not limited to, acetone, chloroform, butanone, toluene, diacetone alcohol, heptanes, tetrahydrofuran, dimethylformamide, carbon disulfide, or combinations thereof. For polymer blocks that contain silicon in them, solvents containing silicon will generally more readily absorb into the film. Hexamethyl-disilizane, dimethylsilyl-dimethylamine, pentamethyldisilyl-dimethyl amine, and other such silylating agents having high vapor pressures may be used in embodiments of the present invention. Moreover, solvent mixtures may also be used, the solvent mixture comprising at least one solvent compatible with each copolymer to ensure proper copolymer swelling to increase polymer mobility.

In order to match a solvent with a block copolymer pair, solubility parameters can be used to identify compatibility between the selected solvent and the polymer blocks of the block copolymer undergoing self-assembly. For example, PS-PDMS systems are commonly solvent annealed with toluene (Jung et al., Nanoletters, Vol. 7, No. 7, p 2046-2050; 2007). The solubility parameter for toluene is 8.9 cal^{1/2}·cm^{-3/2}. The solubility parameters for poly(styrene) and poly(methyldisiloxane) are 9.1 and 7.3 respectively. Thus, in accordance with an embodiment, the solubility parameter of the solvent can be between the solubility parameter of two polymer blocks in a block copolymer so that the solvent can interact with both polymer blocks effectively. The foregoing solvent vapor-assisted annealing gas system can be used to anneal block copolymers that form lamellar, horizontal cylinders, vertical cylinders, or spherical domains. Suitable block copolymers may have χ values in a range from about 0.03 to about 0.30. These block copolymers can be directed by line/space chemical substrates, chemical substrates composed of circular spots, graphical line/space templates, or cylindrical graphical templates

In accordance with another embodiment, the concentration (i.e., partial pressure) of the solvent vapor in the solvent vapor-assisted annealing gas can be correlated to the non-uniformity in the layer of the block copolymer. In this embodiment, the solvent vapor-assisted annealing gas further comprises a carrier gas, such as an inert gas. Exemplary inert gases include, but are not limited to the carrier gas can be nitrogen, neon, argon, or other noble gases elements. The concentration of the solvent vapor in the solvent vapor-assisted anneal gas can be adjusted to by changing the amount of the carrier gas being introduced at various parts of the chamber in correlation to the non-uniformity. Analogous to the thermal anneal system described above, the solvent vapor-assisted annealing gas delivery system can be configured with concentric ringed injection ports or a grid-array of injection ports. Additionally, the solvent selected for the solvent vapor-assisted annealing gas may be correlated to the solubility parameter(s) of the polymer blocks of the block copolymer.

In accordance with another embodiment, a plurality of solvent vapors may be used in the solvent vapor-assisted annealing gas. Typically, one solvent is absorbed by one of the polymer blocks and the other solvent is absorbed by the other polymer block. Utilization of a plurality of solvent vapors in the solvent vapor-assisted annealing gas enables control of both the total pressure (driving force) of the annealing gas across the wafer, and the relative solvent vapor concentration of the component solvent vapors across the process chamber, which enables control of the partial pressure of each of the gases relative to one another in correlation to the non-uniformity in the layer of the block copolymer.

Additionally, in accordance with a further aspect of this embodiment, the solubility parameters the polymer blocks can be utilized to identify the appropriate solvent constituents of the solvent vapor-assisted annealing gas. For example, for a PS-PDMS block copolymer, a mixed solvent system of toluene and n-heptane can be used. The solubility parameters (in cal^{1/2}·cm^{-3/2}) for PS, PDMS, toluene, and heptane are 9.1, 7.3, 8.9, and 7.4, respectively. Accordingly, in this example, the solubility parameter of each solvent in the solvent vapor-assisted annealing gas is within about 1 cal^{1/2}·cm^{-3/2} to one of the polymer blocks. More specifically, in this example toluene is selected based for PS, and n-heptane for PDMS. It should be further appreciated, that while the simplest block copolymer is an A-B type, other types of block copolymers, such as A-B-A type block copolymers or A-B-C block copolymers can also be used. Accordingly, for an A-B-C type block copolymer, 1, 2, or 3 solvents can be present in the solvent vapor-assisted annealing gas composition to anneal these materials. The foregoing plurality of solvent vapors in the solvent vapor-assisted annealing gas system can be used to anneal block copolymers that form lamellar, horizontal cylinders, vertical cylinders, or spherical domains. Suitable block copolymers may have χ values in a range from about 0.03 to about 0.30. These block copolymers can be directed by line/space chemical substrates, chemical substrates composed of circular spots, graphical line/space templates, or cylindrical graphical templates.

While the present invention has been illustrated by a description of one or more embodiments thereof and while these embodiments have been described in considerable detail, they are intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method for treating a layered substrate comprising a layer of a block copolymer, comprising:
a) identifying a non-uniformity in the layer of the block copolymer;
b) controlling a process variable correlated to the non-uniformity in the layer of the block copolymer; and
c) annealing the layer of the block copolymer under a process condition affected by the process variable to compensate for at least a portion of the non-uniformity in the layer of the block copolymer to form a pattern comprising a plurality of domains having improved uniformity therein.

2. The method of claim 1, wherein the non-uniformity comprises a center to edge variation in the layer of the block copolymer.

3. The method of claim 2, wherein the process variable is correlated to the center to edge variation in the layer of the block copolymer, and wherein the process variable is selected from an annealing temperature; a temperature of a purge gas; a concentration of the purge gas; a selection of a solvent in a solvent vapor-assisted annealing gas; a concentration of a solvent vapor in the solvent vapor-assisted annealing gas; or combinations thereof.

4. The method of claim 3, wherein the process variable is the annealing temperature, and wherein the controlling the process variable comprises varying the annealing temperature across the layer of the block copolymer to provide zone heat transfer correlated to the center to edge variation in the layer of the block copolymer.

5. The method of claim 4, wherein varying the annealing temperature comprises heating the layer of the block copolymer with a heat source selected from a hot plate, an optical heat lamp, a laser heat lamp, a microwave heating device, or combinations thereof.

6. The method of claim 3, wherein the process variable is the temperature of the purge gas, and wherein controlling the process variable comprises varying the temperature of the purge gas across the layer of the block copolymer to provide zone heat transfer correlated to the center to edge variation in the layer of the block copolymer.

7. The method of claim 3, wherein the process variable is the concentration of the purge gas, and wherein the controlling the process variable comprises varying the concentration of the purge gas across the layer of the block copolymer to provide zone heat transfer correlated to the center to edge variation in the layer of the block copolymer.

8. The method of claim 3, wherein the process variable is the selection of the solvent in the solvent vapor-assisted annealing gas, and wherein the controlling the process variable comprises selecting the solvent based on a similarity of a solvent solubility parameter of the solvent with respect to a first polymer block solubility parameter of a first polymer block of the block copolymer or to a second polymer block solubility parameter of a second polymer block of the block copolymer.

9. The method of claim 8, wherein the solvent solubility parameter of the solvent is between the first and the second polymer block solubility parameters of the block copolymer.

10. The method of claim 9, further comprising including a second solvent as a component in the solvent vapor-assisted annealing gas.

11. The method of claim 10, wherein a selection of the second solvent is based on a similarity of a solubility parameter of the second solvent with respect to the first polymer block solubility parameter of the first polymer block of the block copolymer or to the second polymer block solubility parameter of the second polymer block of the block copolymer.

12. The method of claim 3, wherein the process variable is the concentration of the solvent vapor in the solvent vapor-assisted annealing gas, and wherein controlling the process variable comprises varying the concentration of the solvent vapor in the solvent vapor-assisted annealing gas across the layer of the block copolymer to provide zone exposure correlated to the center to edge variation in the layer of the block copolymer.

13. The method of claim 12, wherein the solvent vapor-assisted annealing gas further comprises a second solvent vapor, the method further comprising controlling a second concentration of the second solvent vapor in the solvent vapor-assisted annealing gas.

14. A method for reducing a non-uniformity in a layered substrate comprising layer of a block copolymer on a pre-patterned substrate, comprising:
a) identifying the non-uniformity in the layered substrate;
b) controlling a process variable correlated to the non-uniformity in the layered substrate; and
c) annealing the layer of the block copolymer under a process condition affected by the process variable to compensate for at least a portion of the non-uniformity in the layered substrate to form a pattern comprising a plurality of domains having improved uniformity therein.

15. The method of claim 14, wherein the layered substrate comprises a central region surrounded by an edge region, and wherein the non-uniformity is a center to edge variation in the layer of the block copolymer.

16. The method of claim 15, wherein the process variable is correlated to the center to edge variation in the layer of the block copolymer, and wherein the process variable is selected from an annealing temperature; a temperature of a purge gas; a concentration of the purge gas; a selection of a solvent in a solvent vapor-assisted annealing gas; a concentration of a solvent vapor in the solvent vapor-assisted annealing gas; or combinations thereof.

17. The method of claim 16, wherein the process variable is the annealing temperature, and wherein the controlling the process variable comprises varying the annealing temperature across the layer of the block copolymer to provide zone heat transfer correlated to the center to edge variation in the layer of the block copolymer.

18. The method of claim 16, wherein the process variable is the temperature of the purge gas, and wherein controlling the process variable comprises varying the temperature of the purge gas across the layer of the block copolymer to provide zone heat transfer correlated to the center to edge variation in the layer of the block copolymer.

19. The method of claim 16, wherein the process variable is the concentration of the purge gas, and wherein the controlling the process variable comprises varying the concentration of the purge gas across the layer of the block copolymer to provide zone heat transfer correlated to the center to edge variation in the layer of the block copolymer.

20. The method of claim 16, wherein the process variable is the selection of the solvent in the solvent vapor-assisted annealing gas, and wherein the controlling the process variable comprises selecting the solvent based on a similarity of a solvent solubility parameter of the solvent with respect to a first polymer block solubility parameter of a first polymer block of the block copolymer or to a second polymer block solubility parameter of a second polymer block of the block copolymer.

21. The method of claim 16, wherein the process variable is the concentration of the solvent vapor in the solvent vapor-assisted annealing gas, and wherein controlling the process variable comprises varying the concentration of the solvent vapor in the solvent vapor-assisted annealing gas across the layer of the block copolymer to provide zone exposure correlated to the center to edge variation in the layer of the block copolymer.
